(19) United States
(12) Patent Application Publication
(10) Pub. No.: US 2008/0140536 A1
(43) Pub. Date: Jun. 12, 2008

(54) SYSTEMS AND METHODS FOR PURCHASING VIDEOGAMES ACCESS USING MOBILE COMMUNICATIONS DEVICES

(75) Inventors: Pablo Ruiz Tejedor, Madrid (ES); Carlos Abril Benavides, Madrid (ES)

Correspondence Address: BAKER & MCKENZIE LLP;PATENT DEPARTMENT, 2001 ROSS AVENUE, SUITE 2300, DALLAS, TX, 75201, US

(73) Assignee: FX INTERACTIVE S.L., Madrid (ES)

(21) Appl. No.: 11/567,783

(22) Filed: Dec. 7, 2006

(51) Int. Cl. G06Q 30/00

(52) U.S. Cl. 705/26

(57) ABSTRACT

Systems and methods for purchasing video games access using a mobile communication device are disclosed. The video games can be purchased for a predetermined number of game plays; for a fixed period of time, for example allowing the user to play the game for three days; for a fixed period of time within a longer period, for example, any 3 hour period over the next 3 days. In one embodiment game plays or time can be purchased by sending, and receiving upon request, a mobile communication device message to a predetermined number. In another embodiment a video game can prompt the user to determine if the user would like to purchase more video games plays or time. If the user would like to purchase more video game plays or time a server can send a message to the user's mobile communication device.

### BACKGROUND

1. Field of the Invention

The present embodiments described herein relate generally to video games, and more particularly for purchasing video game access using mobile communication devices.

2. Background of the Invention

A “video game” can include “computer games,” “PC games,” “console games,” “arcade games,” along with games made for other devices, including, but not limited to, PDAs, advanced calculators, handheld game devices, etc. In common usage a “computer game” or a “PC game” refers to a game that is played on a personal computer. Computer games can, for example, be downloaded over the internet or purchased on some form of storage media, such as CD's, DVD's, floppy disks, etc. Games downloaded over the internet can be purchased using, for example, a credit card or using a checking account by entering the account number and other identifying information. Games purchased on storage media can be paid for at the store in cash, check, credit card, etc.

A “console game” refers to a game that is played on a device specifically designed for such use while interfacing with a standard television set. The games for console game systems can come in the form of storage media, such as cartridges, CD's, DVD's, etc. These games can be purchased at stores or rented using, for example, cash, check, credit card, etc.

An “arcade game” is generally a coin-operated entertainment machine, typically installed in businesses such as restaurants, pubs, video arcades, and Family Entertainment Centers. Arcade games usually require payment for a certain number of plays. For example, a user can be required to put a coin in the arcade game to play a single play of a game on the machine.

As can be seen from the above examples, many different types of models have been developed for the purchase of video games. In some examples the player can buy the game and use it as many times as he or she wants, for example, when buying a game on a cartridge this will generally be the case, at least as long as the cartridge does not break. In other examples the fee can be for a certain number of plays of the game, for example, when playing an Arcade game that requires coins be input to play the game. In yet other examples the player can rent the use of the game for a predetermined period of time, for as many or as few a number of games as he or she decides to play during that time

Each of these video game purchasing models has certain disadvantages. For example, a coin operated arcade game requires that the player have enough coins to play as many games as he or she wishes to play. If the player does not have any coins then potential video game sales can be lost.

Purchasing games over the internet can require a credit card or a checking account. Not all players will have a credit card or a checking account. Additionally, when purchasing one game play at a time it may not be economical to process a credit card transaction each time a game is played.

Finally, purchasing or renting games can require the game player to travel to the store. This can be inconvenient, for example, the player may want to play the game when the store is closed and thus be unable to rent the game when desired. What is needed is another option when paying for video games.

### SUMMARY

Video games access can be purchased for use on computers, consoles, or arcade games by sending mobile communication device messages, for example, SMS, MMS, etc., to or from the mobile communication device. The price for the access can then, for example, be included in the price charged by the carrier for the message sent or received by the user. Mobile communication devices have become common in many places. By using a mobile communication device to purchase access to video games, the need to have coins to play at an arcade can be eliminated because the price of any games can be billed to the mobile communication device account rather than requiring immediate payment. Additionally, games can be played without needing a credit card or checking account, again because the price of the game plays can be billed to the mobile communication device account. Further, when a console game including the systems and methods described herein is used the player will, in some embodiments, not have to travel to purchase the game. It should be pointed out, however, that the systems and methods described herein permit independence of the distribution channel.

In one aspect a user can send a specific message to a predetermined number using their mobile communication device to either game plays or buy game time, i.e., to purchase game access. The message can be required once or each time a user wants to access a game, depending on what the user is purchasing. For example, users can purchase a predetermined number of plays, a fixed period of time to play a game, or a fixed amount of actual game time. In other words, the user can purchase access to the video game for a predetermined number of plays, a fixed period of time to play a game, or a fixed amount of actual game time. When the number of game plays, the fixed period of time, or the actual game time runs out the user will need to send another message to purchase more plays or more time, or provide some other form of payment.

In another aspect, a subscription system can be used. In a subscription system the system can prompt the user to determine if they would like to purchase more game plays when they are running out of game plays or more time when they are running out of time. If the user responds that they would like to make a purchase a server can send a mobile communication device message to the user. The price of the game plays, or time, can then be charged to the user's mobile communication device account, including any fees for the message and for the games. In one embodiment, a user can be required to reply to the message. This can increase the security of the system and help to eliminate fraudulent purchases by verifying that the person that is trying to purchase more game plays or time is the person that is in possession of the mobile communication device, or at least that the person in possession of the mobile communication device authorizes the purchase. In such embodiments it can be advantageous to charge for the game play or time in conjunction with the reply message so that no charges occur until after the verification. Alternatively, charges to the original message can be reversed if a reply is not received.

In still another, aspect the user can register so that the system will know where to send future messages by sending a predetermined mobile message to a specific telephone number. It should be noted that the predetermined telephone number is a telephone number associated with the system and not the user's telephone number. When the user starts a game, the video game can connect to a server and verify that the user has available game play, time, etc. If so, the video game can be played. If the user does not have any game play or time left the user can be prompted to determine if the user would like to purchase more game plays or more game time, etc. If the user wants more game plays a message can be sent to the user's mobile communication device by using the telephone number determined or supplied during registration. In certain embodiments for example, the user can request more game plays, or game time, e.g., via a specific button included in, or as part of the game. When such a button is activated, or request is received, then the game can communicate with the server through the software of the system.

The message sent to the user can, for example, state that more game plays or time has been added to the user's game account, or that the user must reply to the message before more game plays can be added. The price of the game plays can be charged to the user's mobile communication device account, including the price of the message or messages.

The systems and methods described herein are and permit the independence of the distribution method. For example, games can be downloaded over the internet, available on CD, DVD, or other medium, downloaded using a system specific communication system, etc.

The game can be run on a computer, console, or arcade game, etc. Alternatively, the game can run on a server that is connected to the computer, console, or arcade game. The server and computer can be connected, e.g., by the internet.

Regardless of where the game is run or how the game software is distributed a user's mobile communication device can be used to purchase the game plays, game time, etc. Games can be purchased on a per-play basis, for a predetermined period of time, for a predetermined playing time. For example, usage for a predetermined period of time or playing time for a certain price.

These and other features, aspects, and embodiments of the invention are described below in the section entitled “Detailed Description.”

### BRIEF DESCRIPTION OF THE DRAWINGS

For a more complete understanding of the systems and methods described herein, and the advantages thereof, reference is now made to the following descriptions taken in conjunction with the accompanying drawings, in which:

FIG. 1 is a diagram illustrating an example system for purchasing video game plays or video game time in accordance with one embodiment;

FIG. 2 is a diagram illustrating an example system for purchasing video games plays or video game time in accordance with another embodiment;

FIG. 3 is a flowchart illustrating an example method of video game plays or video game time purchase processing by sending a mobile message using the system of FIG. 1 in accordance with one embodiment;

FIG. 4A-4C are flowcharts illustrating an example method of video game plays or video game time purchase processing by sending a message to a mobile communication device using the system of FIG. 2 in accordance with one embodiment;

FIG. 5 is a flowchart illustrating an example method for using game plays or time that is purchased, wherein the check for available game plays or time occurs when the user opens the game;

FIG. 6 is a flowchart illustrating an example method for using game plays or time that is purchased, wherein the check for available game plays or time occurs when the user is already in the game; and

FIG. 7A-D are flowcharts illustrating example methods for user registration.

### DETAILED DESCRIPTION

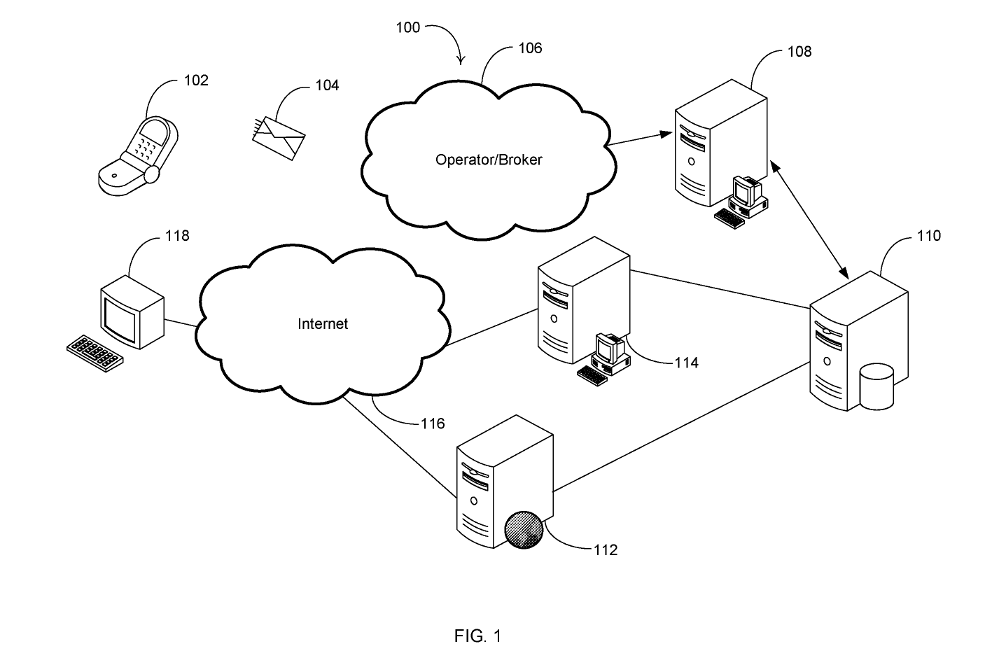

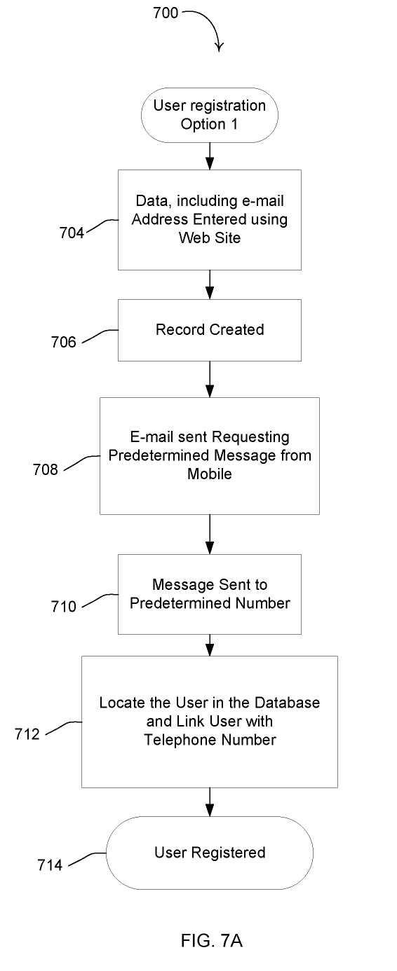

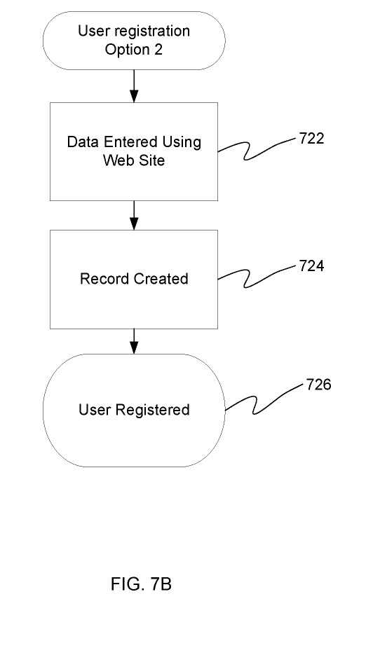

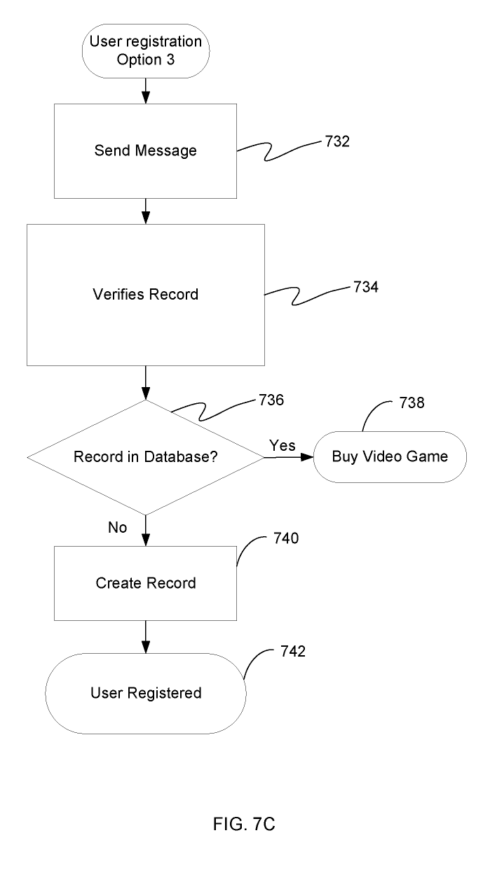

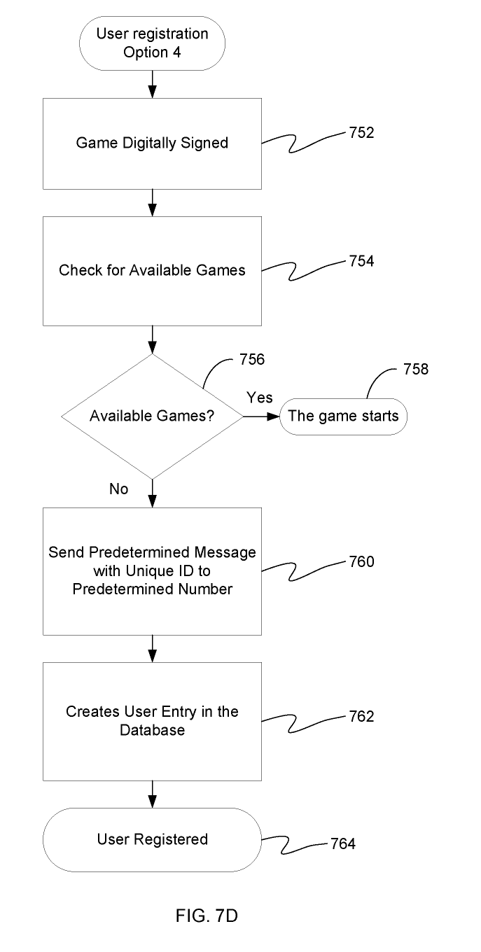

FIG. 1 is a simplified diagram illustrating an example system 100 for purchasing video games plays or video game time, i.e., video game access, in accordance with one embodiment. In this embodiment a user can register and subscribe to a video game access purchasing service. For example, the user can register by entering data including, e.g., the user's mobile communication device telephone number, at a web page. This data can then be stored in a database. In this way it can be possible to identify the user based on the user's mobile communication device telephone number. Registration will be discussed further with respect to FIGS. 7A-D. Once registered the user can subscribe to a game access purchasing service. Subscribing can be as simple as not requesting that data stored during registration be deleted.

Once the user is registered and has subscribed to the service, the user can purchase video games by purchasing a predetermined number of game plays, a fixed period of time to play a game or a fixed amount of playing time. For example, in certain embodiments a predetermined number of game plays, for one or more games, can be purchased. For example, assume that a game server has two games, Game 1 and Game 2. Further assume that the user purchases a total of ten game plays. In some embodiments this can allow the user to play Game 1 ten times or Game 2 ten times. In other embodiments this can allow the user to play any combination of Game 1 and Game 2 up to a total of ten times. For example, five plays of Game 1 and five plays of Game 2. In this embodiment, it is simply up to the user what combination of games to play.

In another embodiment, a fixed period of time to play a game can be purchased. Similar to the example above, the fixed period of time can be on one or more games. Thus, if 3 days of use were purchased a user can be allowed to play both Game 1 and Game 2 as many times as he or she would like over the 3 day period. Alternatively, the user could be required to pick a single game, e.g., Game 1, or a small number of games from a larger set of games to play over the predetermined period. The selection of games can occur during the subscription process for example.

In another embodiment, a user can purchase a predetermined period of cumulative playing time. For example, a user can purchase 10 hours of actual playing time and play those ten hours over a longer period of time, for example, days, months, or longer.

If the user would like to purchase more video games plays or game time, e.g., a predetermined number of game plays, a fixed period of time to play a game, a fixed amount of playing time, the user can use a mobile communication device 102, e.g., the mobile communication device registered with the system, to transmit a specific message 104 to a predetermined telephone number.

It will be understood that mobile communication device 102 can be any device that can send and/or receive messages, such as mobile telephone messages, e.g., SMS messages, MMS messages, etc. Thus, mobile communication device 102 can be a mobile telephone, a mobile handset, a mobile telephone handset, a cellular telephone (cell phone), a PDA, or any other type of portable telephone.

Message 104 can be sent manually by the user or message 104 can be a preset message in the mobile communication device 102. Further, message 104 can be, e.g., an SMS message, an MMS message, etc.

Message 104 can be sent over a mobile communication device network 106, e.g., a mobile communication device service provider's network, to a server 108. In other words, the mobile communication device 102 can send the message using whatever standard messaging protocols and services device 102 uses to send other messages, for example, other SMS messages or MMS messages, etc. Thus, mobile communication device network 106 can include base stations, which can include transceivers for sending and receiving messages to and from mobile communication device 102. Mobile communication device network 106 can include both wireless and wired connections. For example, multiple base stations in a network 106 can communicate using, e.g., wireless transmissions, landline telephone, microwave, satellite, and other communication systems. Additionally, it will be understood that a combination of mobile network 106, including any communication systems used between base stations, can be combined with wireless transmissions, landline telephone, microwave, satellite, and other communication systems to transmit message 104 from mobile communication device 102 to server 108.

Server 108 can manage the mobile messages sent from subscribing user's mobile communication devices 102. For example, server 108 can receive the message 104 and, using the mobile communication device telephone number associated with the message, look for the user with this telephone number. For example, server 108 can be in communication with User Database Server 110, which can include registration information that the user entered when they registered for the service. In embodiments that require registration, when the mobile communication device telephone number received is not registered, server 108 can send a message to mobile communication device 102 indicating that the user is not registered.

When message 104 is received server 108 can update the user database stored in server 110 to add more games to the user's game account. This can occur, for example, when the user is registered, or alternatively, this can occur automatically in systems that do not require that a user be pre-registered.

Server 110 can be connected to web server 112 and game management server 114. In one embodiment web server 112 can be used to run web based game software. In this way some or all of the processing for a game that a user is playing can be performed remotely, rather than on the user's computer 118. This can lower the performance requirements of computer 118.

Client software, running on computer 118, can connect to game management server 114, which can check the database on server 110 to determine if the user has more game plays or time available. Thereby either allowing the user to play the game when more game plays or time are available or denying access to the game when none are available. If no game plays or time are available, the user can be prompted to purchase more in the manner described above.

Web server 112 and game management server 114 can be connected, to computer 118, e.g., using the internet 116. Computer 118 can be, for example, a computer, a game console, an arcade game along with any other game device, including, but not limited to, mobile phones, PDAs, advanced calculators, etc.

It will be understood that one or more of the functions of servers 108, 110, 112, and 114 can be performed by one or more servers. For example, in one embodiment, all of the functions can be performed on a single server. Alternatively, the functions can be spread across multiple servers, redundant servers, etc. Additionally, as discussed above, it will be understood that, depending on the embodiment, that functionality of the game can be split between computer 118 and web server 112, or reside entirely on computer 118.

While the example of the system of FIG. 1 includes registration and subscription, it will be understood that in other embodiments games plays or access can be purchased by using mobile communication device 102 to transmit message 104 without registering, subscribing, or both.

When a user purchases a predetermined number of game plays, in one embodiment, these game plays can be used for any Games that are available on a server. This is similar to having coins and being in an arcade. A user can use one coin to play one game on a particular game machine and then use another coin and try a different game on a different game machine. In one embodiment that allows a user to purchase a predetermined number of plays the user can switch from game to game using one game playing credit for each play of a particular game. Alternatively, in another embodiment purchased game plays can be game specific. In other words, users purchase the ability to play one specific game or one specific game machine.

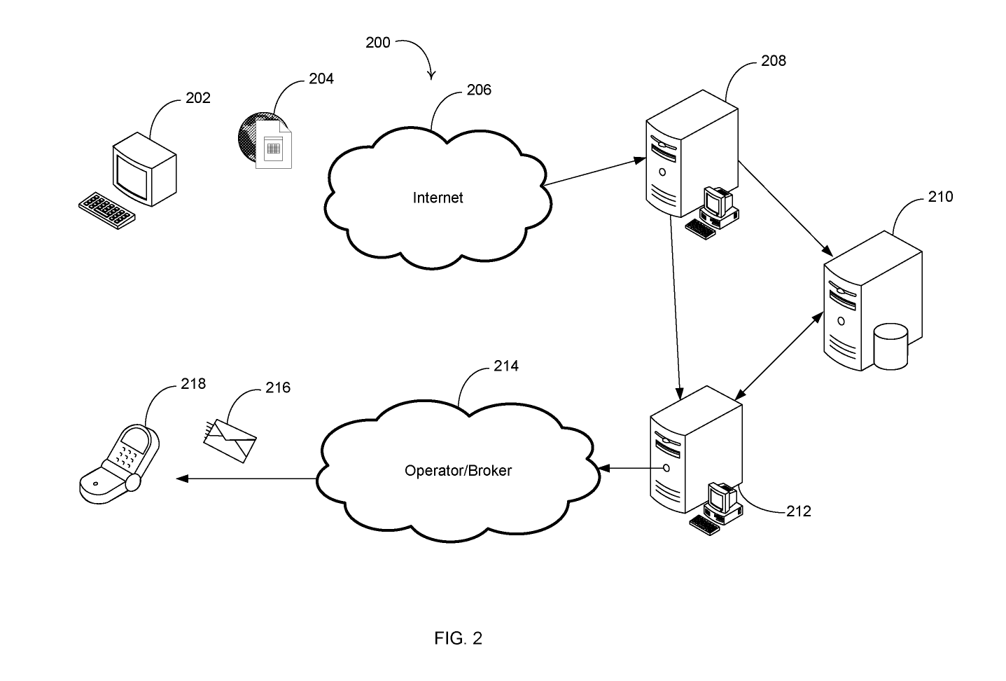

FIG. 2 is a diagram illustrating an example system for purchasing video games or video game access 200 in accordance with another embodiment, in which games are purchased by sending a message 216 from a server 212 to a mobile communication device 218. FIG. 2 is similar to FIG. 1, however, in FIG. 2 a request to purchase more games 204 can be made at computer 202 and transmitted using, e.g., the internet 206 to a game management server 208. Mobile Message Management Server 212 can be in communication with mobile communication device 218. When request 204 is received, server 212 can be configured to then transmit a message 216 to mobile communication device 218 using mobile communication device network 214, e.g., a mobile communication device service provider's network. It will be understood that a combination of mobile network 214, including any communication systems used between base stations, can be combined with wireless transmissions, landline telephone, microwave, satellite, and other communication systems to transmit message 216 from server 212 to mobile communication device 218.

Message 216 can be a mobile communication device message sent from server 212 to mobile communication device 218 that can include text that informs the user that additional games, and/or time have been purchased. The message can, for example, include the number of game plays purchased, the amount of time purchased, etc. Further, message 216 can, in one embodiment, explain to a user how to acknowledge or validate the purchase of the game plays or time. For example, the user can be allowed to respond to the message to indicate that the user intended to make the purchase or that the user did not make the purchase. If the user did not make the purchase, the additional game plays, and/or time can be removed and the purchase price and message price can be removed from the user's bill.

Similar to FIG. 1, a user database server 210 can be connected to servers 208 and 212. The database server can, for example, store user registration information. A web server, not shown, can also be included in the system. The web server can, for example, be used to run web based games, as was discussed with respect to FIG. 1. It will be understood that one or more of the functions of servers 208, 210, 212, and the web based server, can be performed by one or more servers. For example, as discussed with respect to FIG. 1, in one embodiment, all of the functions can be performed on a single server. Alternatively, the functions can be spread across multiple servers, redundant servers, etc. It will be further understood that, depending on the embodiment, the functionality of the game can be split between computer 202 and a web server.

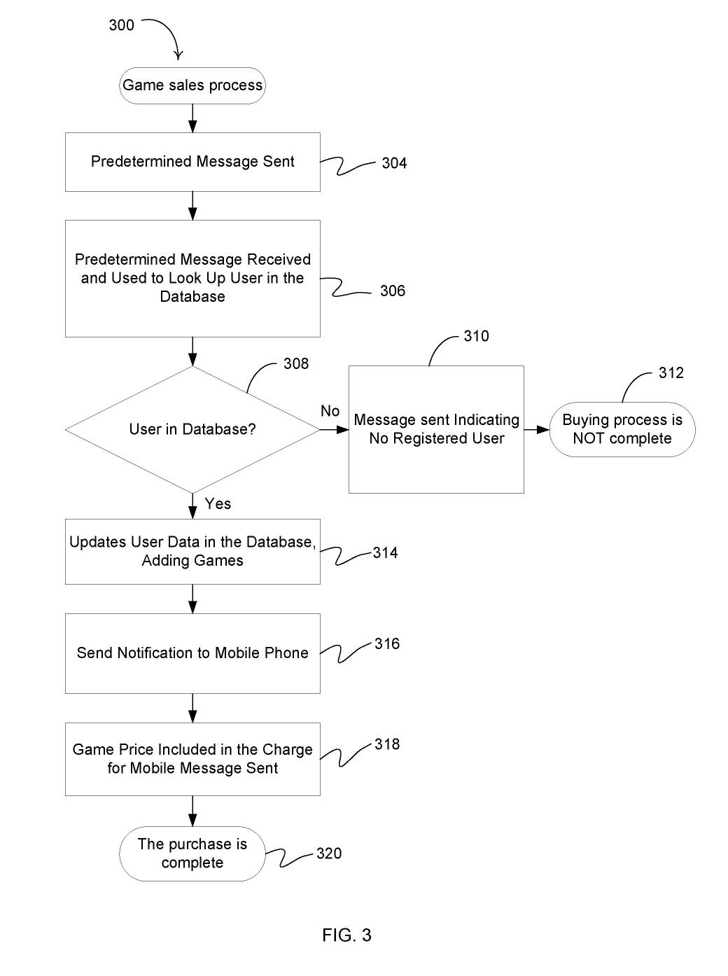

FIG. 3 is a flowchart illustrating an example method of video game plays or time (video game access) purchase processing by sending a mobile message using the system of FIG. 1 in accordance with one embodiment. In this example, game plays or time (video game access) can be purchased by sending a predetermined message from a mobile communication device to a predetermined telephone number. The fee for the games can be charged to the user's mobile communication device bill as part of the cost of the message.

It will be understood that charging a fee for games to the user's mobile communication device bill can require interaction between, e.g., the video game provider and the mobile communication device service provider. It will generally be necessary to identify messages that should include a charge for game plays or time purchases. Further, charges for each message can vary based on the type of Game, the number of game plays purchased, the amount of time purchased, etc.

Identification of the message or messages and associating the cost of the game plays or game time, etc. purchase with the message or messages can be implemented in a number of ways. For example, such a process can be implemented using the fees and mechanisms already in place in the current “Premium” messages. Further, in one embodiment, the video game provider can simply send a list to the mobile communication device service provider that indicates by users and/or telephone numbers each message and how much to charge for the message. In another embodiment, information can be coded into the message that indicates, for example, how much to charge for the message.

It will be understood that this can require the mobile communication device service provider and the video game provider to agree on a system for including the information in the message. This system can, for example, vary depending on the type of message, SMS, MMS, etc. or for different mobile communication device service providers, video game service providers, etc. Alternatively, one system can be used so that each service provider can be compatible with any other service provider. In one embodiment, the system used can be similar to other types of services that are charge to telephone bills, for example Pay-Per-Call services.

A user can send a predetermined message to a predetermined number from a mobile communication device in step 304. The message can be an SMS message, an MMS message, or other type of mobile communication device message. The message can be required once or each time a user wants to access a game, depending on what the user is purchasing. For example, users can purchase a predetermined number of plays, a fixed period of time to play a game, a fixed amount of playing time.

In systems that require a user to pre-register, mobile message management server 108 can receive the message and, e.g., using the mobile number associated with the message, look for a user with this telephone number in a database in step 306. In step 308, if there is a user with the received mobile number in the database, then message management server 108 can update the user database to add more game plays or time to the user's game account.

In systems that require a user to pre-register, if there is not a user with this mobile communication device telephone number in the database, a message can be sent to the originating telephone number in step 310. The message can indicate that there is not a registered user with that telephone number. In step 312 the buying process is not completed.

In step 316, a message can be sent to mobile communication device 102 indicating a successful transaction. This step can be optional, however, some countries require parity between the number of messages received from a user and the number of messages sent to the user. In these countries the message indicating a successful transaction can provide the required parity between the number of messages. The game play or time price can be included in the cost charged to the user for the mobile message sent, step 318, and the purchase can then be complete at step 320.

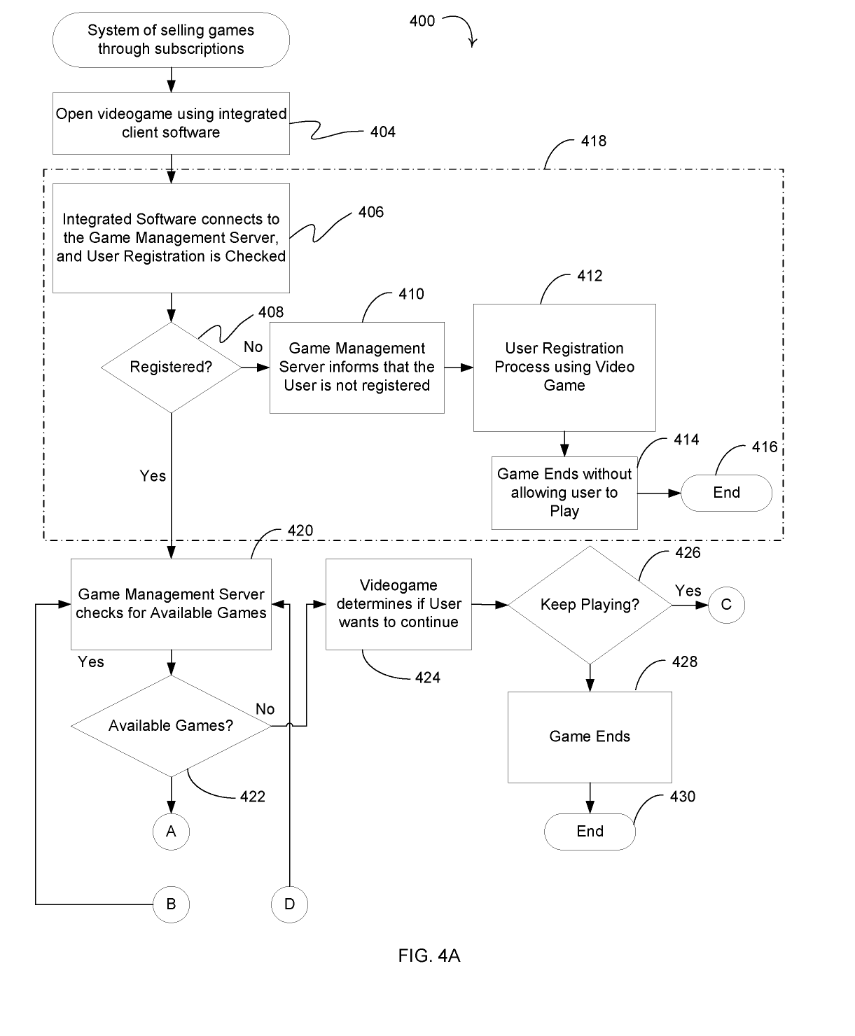

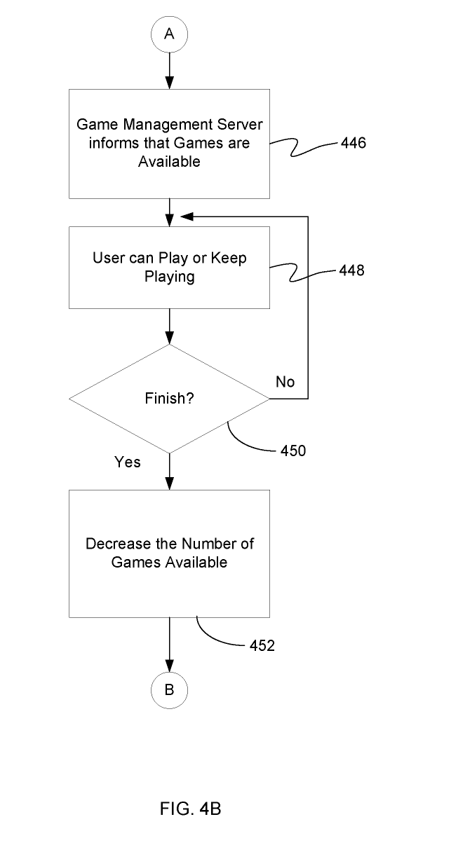

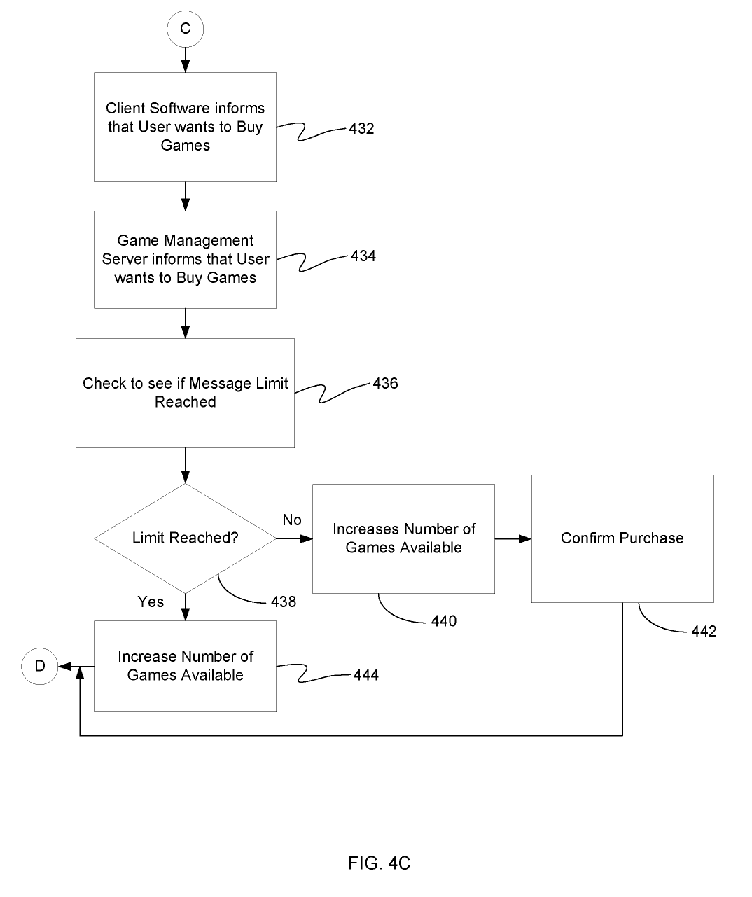

FIGS. 4A-4C are flowcharts illustrating an example method of video game plays or time (video game access) purchase processing by sending a message to a mobile communication device using the system of FIG. 2 in accordance with one embodiment. In step 404 a user opens a video game using integrated client software installed on computer 202. The integrated client software can be, for example, software that runs on computer 202 that allows the computer to play games using the systems and methods described herein. This software can provide for downloading games from a server or running game software using a web server, or some combination of the two.

In step 406 the client software can connect to game management server 208 which can check a database to determine if a user is registered to use the video game purchasing service. If the user is not registered game management server 208 can inform the client software that the user is not registered in step 410 and the software running on computer 202 can allow the user to register in step 412 using mobile device 218. For example, the software can instruct the user to send a specific message to a preset number to complete registration and/or subscription, step 412. Registration will be discussed further with respect to FIGS. 7A-D. In step 414 the user is unable to play the video game, because the user is not registered, and the process ends in step 416. As indicated by box 418, these steps can be optional, for example if pre-registration is not required.

In step 420 game management server 208 can check the database to determine if the user has any available game plays or time. If game plays or time are available, as determined in step 422, then game management server 208 can inform the client software that game plays or time are available in step 446 (FIG. 4B). This can cause the video game to allow the player to play or continue to play a video game in step 448. The video game continues to play until the game is finished in step 450. “Finished” can be defined by the actual video game played. For example, in one game a player may have three “lives.” After the player is killed three times the game is over. Additionally, the player may earn additional “lives” for completing certain tasks in the game. It will be understood that these characteristics of the game can vary from game to game. For example, in another game, a user can have a certain number of space ships, rather than a certain number of “lives,” or the number of “lives” can vary from game to game. Finishing can also be related to a user not obtaining some objective, not finishing a certain level within the game, game playing time being over, etc.

In step 452, when the game is finished the client software can connect to game management server 208. Game management server 208 can decrease the number of game plays, game time, etc. available to the user by modifying the database. In another embodiment the number of game plays available can be decreased at the start of the game.

If the user does not have more game plays or time available in step 422 (FIG. 4A) the video game can prompt the user to determine if he or she wants to play or keep playing a Game. If an indication is received indicating that the user does not want to continue playing at step 426, then the Video game does not allow the user to continue play at step 428, and the Game ends at step 430.

In step 426, when the user wants to continue playing, the client software can inform game management server 208 that the user wants to buy game plays or time at step 432 (FIG. 4C). This information can be passed on to message management server 212 at step 434 and message management server 212 can check to see if any daily or monthly message limit has been reached at step 436. In one embodiment, if the limit has been reached in step 438 then message management server 212 can increase the user's number of game plays or time without sending a message to the user's mobile communication device, in step 444. A message can be sent at a later time when the message limit is no longer reached. For example, if the user is allowed 1000 messages per month when the next month is reached the user will have 1000 more messages that can be sent. Game management server 208 can then check to determine if there are available game plays or time. In this way, the user can continue to play games even when the maximum number of messages has been reached. Alternatively, the user can be denied access to additional games when the maximum number of messages, if there is one, has been exceeded, or an alternative method of payment can be used, for example, credit cards, etc.

Assuming that the maximum number of messages, if there is one, has not been reached, then message management server 212 can increase the user's number of game plays or time in the database at step 440 and message management server 212 can send a message to the user's mobile communication device 218 confirming that the purchase has been made in step 442. The price of the game plays or time can be included in the cost of the message sent.

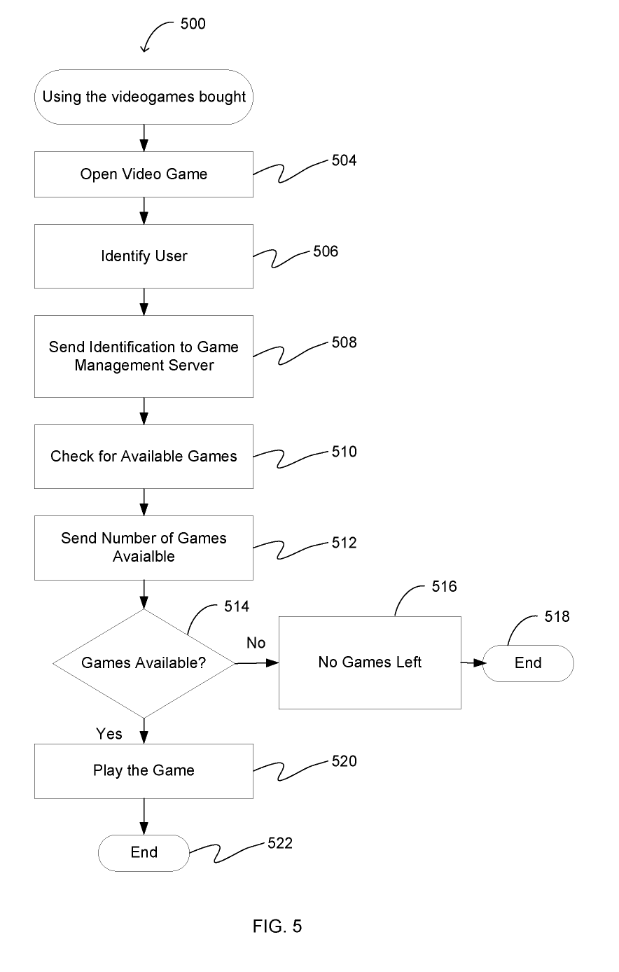

FIG. 5 is a flowchart illustrating an example method for using game plays or time (access) purchased in accordance with the systems and methods described above, wherein a check for available game plays or time can occur when the user opens the game. In step 504 a user can open a Video game using integrated client software. The integrated client software can be software that runs on computers 118 and/or 202. For example, in embodiments that allow the user to request more game plays or time from computer 202 the integrated client software can contain that functionality. Additionally, the integrated client software can provide the functionality necessary for computers 118 and 202 to interact, e.g., over the internet with the various servers, 108, 110, 112, 114, 208, 210, and 212 that are part of the system.

In one embodiment, at step 506, the user can be required to identify him or her self before using the video game and/or the integrated software. In other embodiments the video game can be digitally signed, have an internal key associated with the user, etc. The digital signature or internal key can exempt the user from having to provide other identification.

In step 508 client software can connect to a game management server, which can interface with a user data server to verify the user's identification and determine if a user is registered. The game management server can check the database to determine if a user has available game plays or time in step 510 and the game management server can send the number of game plays to the client software in step 512 so that the user can play, e.g., access a certain amount of playing time or game plays.

If the user does not have available game plays or time in step 514, then the Video game can notify the user that he or she cannot play because no plays or time are left at step 516. The process can then end at step 518. If the user has games, however, the client software can allow the user to play the Game or Games in step 520 until such time that the user runs out of Games or decides to stop playing. The process will then end at step 522.

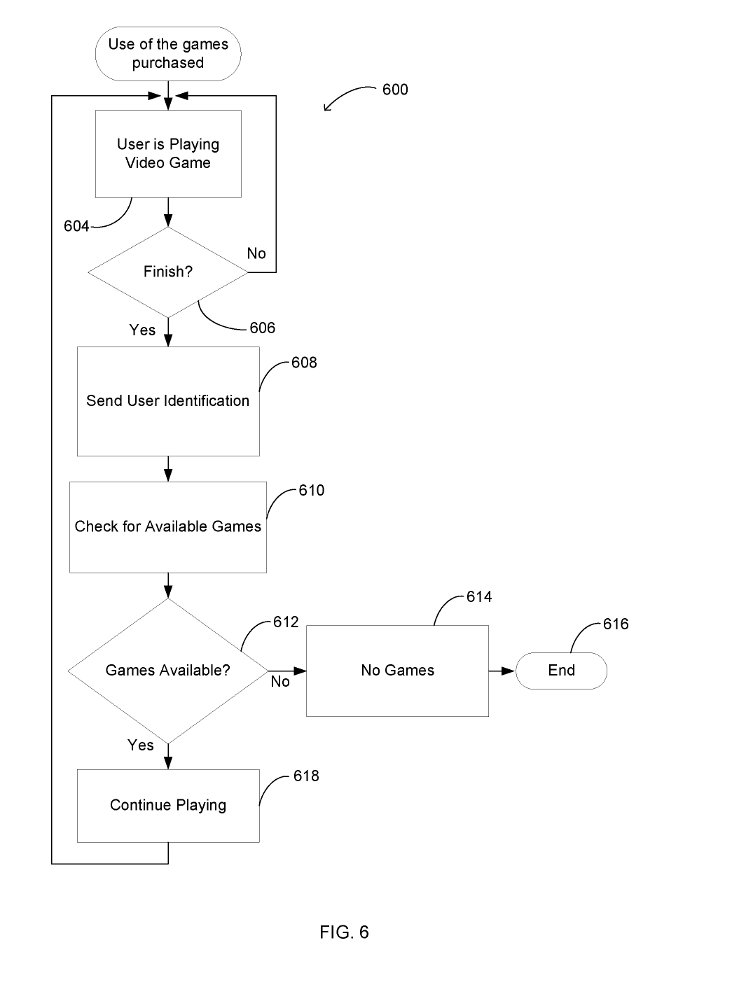

FIG. 6 is a flowchart illustrating an example method for using plays or time (access) purchased in accordance with the systems and methods described above, wherein the check for available plays or time occurs when the user is already in the Game. At step 604 a user is playing a Video game, e.g., one or more plays or time are available. The client software can check the availability of additional plays or time after the Video game has finished at step 606 by connecting to the game management server and sending the user's identification in step 608.

The game management server can check the database to see if the user has available plays or time left in step 610. If no additional plays or time are available at step 612, the Video game can notify the user that she or he cannot play additional plays or time because the user has no plays or time left at step 614. At this point the process can end at step 616. Alternatively, the user could purchase additional plays or time using the systems and methods described herein, not shown on the flow chart. When the user has more plays or time available he or she can simply continue play at step 618.

FIG. 7A-D are flowcharts illustrating example methods for user registration. Several example options for user registration will be discussed. Information for registration can be entered using a web page and a mobile communication device. This is option 1, discussed with respect to FIG. 7A. In another embodiment information for registration can be entirely entered using a web page. This is option 2, discussed with respect to FIG. 7B. In option 3 a user can send a registration message using a mobile communication device and the system can verify if the user is already registered. Option 3 is discussed with respect to FIG. 7C.

In another embodiment, option 4, each copy or installation of a game can have a unique identification or password. The user can therefore be identified by the unique identification or password. This information can be included in any messages sent from a mobile communication device to identify the user and the mobile communication device account can be billed for any games played by that user. Option 4 is discussed with respect to FIG. 7D.

Additionally, registration can be done directly from the game running on the user's computer, game console, etc. For example, a game, mobile communication device based registration similar to option 1 can be used. In other words, some of the information can be entered using prompts from the game and some of the information can be entered by sending a message from a mobile communication device. In another embodiment a game based registration similar to option 2 can be used. Thus, any needed information can be entered using prompts from the game console.

In user option 1, at step 704, a user can use a browser to view a web page that can allow the user to enter his or her data, such as name, e-mail address, etc. without entering a telephone number for a mobile communication device. A record that includes the entered data can then be created in a user database at step 706. The user can then be prompted using the e-mail address provided to send a predetermined message including a unique identification from his or her mobile communication device at step 708. The user can then send the message to the predetermined number at step 710. At step 712 the message management server can locate the user in the database using the unique identification contained in the message and link the user mobile communication device telephone number and the information entered using the web page based on the unique identification contained in the message. Registration in the database can be completed at step 714.

Using option 2, a user can use a browser to view a web page that can allow the user to enter his or her data, including a telephone number for a mobile communication device at step 722. A record can then be completed without requiring the use of a mobile communication device based on the information entered on the web at step 724 and registered in the database can be completed at step 726. In this way registration can be completed using fewer steps and without needing to send any messages over a mobile communication device. Option 1 however, can help to ensure that the person registering is actually in possession of the mobile communication device that is being registered.

In option 3 a user can send a registration message using a mobile communication device and the system can verify if the user is already registered. At step 732 a user can send a predetermined message to a predetermined telephone number from his or her mobile communication device. The mobile message management server can receive the message and using the mobile communication device telephone number associated with the message, verify if there is a record with the associated number already in the database at step 734. If the mobile communication device telephone number is already in the database at step 736 processing for the purchase of video games plays or time (access) can occur at step 738. Alternatively, a new record can be created using the mobile communication device telephone number received at step 740 and the user registration can be entered into the database with the associated mobile communication device telephone number at step 742.

In another embodiment, option 4, each copy or installation of a game can have a unique identification or password. At step 752 a game can be digitally signed with a unique identification and/or a unique password for each copy. The user can therefore be identified by the unique identification or password. At step 754 the client software can connect to the game management server, which can check the database to determine if a user has available plays or time. If the user has available plays or time at step 756 the Game can start at step 758.

Alternatively, if the user does not have available plays or time in step 756 the user can be told to send a predetermined message including the unique identification of the game copy, and/or the password associated with that copy to a predetermined number from the user's mobile communication device at step 760. In this way the game played and the mobile communication device that should be billed for the game can be associated with each other so that the correct mobile communication device can be billed for the games that are played using that copy of the game.

At step 762 the mobile message management server can interpret the message and create a user entry in the database, including the mobile telephone number the message was sent from. User registration in the database can be completed at step 764. Alternatively, by using a unique identification or password in each copy or installation of a game any games played can be billed to different mobile communication device. Any mobile communication device that sends a message including the identification or password can be used to purchase plays, time, etc. Thus, the mobile telephone account billed can be changed as many times as the user or users want, simply by sending messages from different mobile communication devices. It will be understood that the options discussed above are examples. Other registration options are possible, for example, combinations of the example options above.

Additionally, as discussed above, a fifth option is also available. Registration can be done directly from the game running on the user's computer, similar to options 1 or 2.

As discussed above, the systems and methods described herein are independent of the distribution method. Games can be downloaded over the internet, available on CD, DVD, or other medium, downloaded using a system specific communication system, etc. The game can be run on a computer, console, or arcade game or on interactive mobile devices, PDAs, advanced calculators, handheld game devices, etc.

Alternatively, the game can run on a server that is connected to the computer, console, or arcade game, etc. The server and computer can be connected using, e.g., the internet. Regardless of where the game is run or how the game software is distributed a user's mobile communication device can be used to purchase the game on a per-play basis, for a predetermined period of time, for a predetermined playing time.

While certain embodiments of the inventions have been described above, it will be understood that the embodiments described are by way of example only. Accordingly, the inventions should not be limited based on the described embodiments.

What is claimed is:

1. A method for purchasing access to a video game comprising:
receiving a message at a game management server, the message having been sent using a mobile communication device, the message indicating a desire to purchase access to the Video game;
the game management server updating a user's game account to make the Video game available; and
charging for the message, wherein the price of the message includes the price of access to the video game.

2. The method of claim 1, wherein the message comprises a predefined message stored in the mobile communication device.

3. The method of claim 1, wherein the message is sent to a predetermined telephone number.

4. The method of claim 1, further comprising using a telephone number associated with the message to identify the correct game account.

5. The method of claim 1, wherein access is purchased for a computer game.

6. The method of claim 1, wherein access is purchased for a console game.

7. The method of claim 1, wherein access is purchased for an arcade game.

8. The method of claim 1, wherein the access to the video game is for a number of game plays.

9. The method of claim 1, wherein the access to the video game is for a fixed period of playing time.

10. The method of claim 1, further comprising a message management server sending a confirming message to the mobile communication device to confirm the purchase.

11. The method of claim 1, further comprising a video game machine prompting the user to determine if they would like to purchase further access.

12. The method of claim 11, wherein the prompt occurs when there is no access left in the user's game account.

13. The method of claim 11, wherein the prompt occurs when there are a predetermined number of game plays left in the user's game account.

14. The method of claim 11, wherein the prompt occurs when there is a predetermined of game time left in the user's game account.

15. The method of claim 1, further comprising receiving a registration request from the user, the registration request sent at least in part via the mobile communication device.

16. The method of claim 15, wherein the registration message comprises a predetermined message.

17. The method of claim 1, further comprising receiving a registration request from the user, the registration request sent at least in part via the internet.

18. The method of claim 1, further comprising receiving a registration request from the user, the registration request sent at least in part via the video game.

19. The method of claim 1, further comprising determining if the user has additional game plays or time available in the user's game account using a game's unique identification number.

20. The method of claim 1, further comprising determining if the user has additional game plays or time available in the user's game account using a game's unique password.

21. The method of claim 16, wherein the predetermined message is sent to a specific telephone number.

22. A method for purchasing access to a video game comprising:
receiving a request at a game management server from a computer, the request indicating a desire to purchase access to the video game;
sending a message from the game management server to a mobile communication device, in response to the request from the computer, confirming a desire to purchase access to the video game;
the game management server updating a user's game account to make the video game available; and
charging for the message sent to the mobile communication device, wherein the price of the message includes the price of access to the video game.

23. The method of claim 22, wherein access is purchased for a computer game.

24. The method of claim 22, wherein access is purchased for a console game.

25. The method of claim 22, wherein access is purchased for an arcade game.

26. The method of claim 22, wherein the access to the video game is for number of plays of a game.

27. The method of claim 22, wherein the access to the video game is for a fixed period of playing time.

28. The method of claim 22, further comprising receiving a reply message from the mobile communication device.

29. The method of claim 28, wherein the reply message must be received before games can be accessed by the user and the user's game account can be updated.

30. The method of claim 22, wherein the computer prompts the user to determine whether the user wants to purchase access to the video game when there are no games left in the user's game account.

31. The method of claim 22, wherein the computer prompts the user to determine whether the user wants to purchase access to the video game when there are a predetermined number of games left in the user's game account.

32. The method of claim 22, further comprising receiving a registration request from the user, the registration request sent at least in part via the mobile communication device.

33. The method of claim 32, wherein the registration message comprises a predetermined message.

34. The method of claim 22, further comprising receiving a registration request from the user, the registration request sent at least in part via the internet.

35. The method of claim 22, further comprising receiving a registration request from the user, the registration request sent at least in part via the video game.

36. The method of claim 22, further comprising determining if the user has additional game plays or time available in the user's game account using a game's unique identification number.

37. The method of claim 22, further comprising determining if the user has additional games plays or time available in the user's game account using a game's unique password.

38. The method of claim 34, wherein the predetermined message is sent to a specific telephone number.

39. A system for purchasing access to a video games comprising:
a user game account database configured to store information related to at least one video game user;
a game management server configured to:
receive a message at a game management server, the message having been sent using a mobile communication device, the message indicating a desire to purchase access to the video game;
update a user's game account to make the video game available; and
charge for the message, wherein the price of the message includes the price of access to the video game.

40. The system of claim 39, wherein the server receives the message, the message being sent using a mobile communication device and the message indicating a desire to purchase access to the video game.

41. The system of claim 39, wherein the server receives a request indicating a desire to purchase access to the video game from the video game device and sends the message to the mobile communication device, responsive to the request from the video game device.

42. The system of claim 39, wherein the server comprises a mobile message management server.

43. The system of claim 39, wherein the server comprises a users database server.

44. The system of claim 39, wherein the server comprises a video game master server.

45. The system of claim 39, wherein the access purchased is access to a computer game.

46. The system of claim 39, wherein the access purchased is access to a console game.

47. The system of claim 39, wherein the access purchased is access to an arcade game.

48. The system of claim 39, wherein the access to the video game is for a number of plays of a game.

49. The system of claim 39, wherein the access to the video game is for a fixed period of playing time.

50. A system for purchasing access to a video games comprising:
a user game account database configured to store information related to at least one video game user;
a game management server configured to:
receive a request at a game management server from a computer, the request indicating a desire to purchase access to the video game;
send a message from the game management server to a mobile communication device, in response to the request from the computer, confirming a desire to purchase access to the video game;
update a user's game account to make the video game available; and
charge for the message sent to the mobile communication device, wherein the price of the message includes the price of access to the video game.

51. The system of claim 50, wherein the server receives the message, the message being sent using a mobile communication device and the message indicating a desire to purchase access to the video game.

52. The system of claim 50, wherein the server receives a request indicating a desire to purchase access to the video game from the video game device and sends the message to the mobile communication device, responsive to the request from the video game device.

53. The system of claim 50, wherein the server comprises a mobile message management server.

54. The system of claim 50, wherein the server comprises a users database server.

55. The system of claim 50, wherein the server comprises a video game master server.

56. The system of claim 50, wherein the access purchased is access to a computer game.

57. The system of claim 50, wherein the access purchased is access to a console game.

58. The system of claim 50, wherein the access purchased is access to an arcade game.

59. The system of claim 50, wherein the access to the video game is for a number of plays of a game.

60. The system of claim 50, wherein the access to the video game is for a fixed period of playing time.
